(19) United States
(12) Patent Application Publication
(10) Pub. No.: US 2026/0327440 A1
(43) Pub. Date: Oct. 22, 2026

(54) COATING SYSTEM

(71) Applicant: PPG Coatings (Tianjin) Co., Ltd., Tianjin (CN)

(72) Inventors: Liming Song, Tianjin (CN); Xin Wang, Tianjin (CN); Wei Wei, Tianjin (CN)

(73) Assignee: PPG Coatings (Tianjin) Co., Ltd., Tianjin (CN)

(21) Appl. No.: 19/107,746

(22) PCT Filed: Sep. 1, 2023
(86) PCT No.: PCT/CN2023/116484

§ 371 Date: Feb. 28, 2025

(30) Foreign Application Priority Data
Sep. 2, 2022 (CN) 202211072732.2

(51) Int. Cl. C09D 5/36; C09D 7/43; C09D 7/61; C09D 7/65; C09D 133/04; C09D 151/08

(52) U.S. Cl. CPC C09D 5/36; C09D 7/43; C09D 7/61; C09D 7/65; C09D 133/04; C09D 151/08

(57) ABSTRACT

Disclosed is a coating system, comprising: a lower coating formed from a first coating composition, and an upper coating formed from a second coating composition including an effect pigment, the first coating composition and the second coating composition being cured simultaneously, wherein the upper coating has a dry film thickness of 3-20 μm, and a difference between foil solid contents of the lower coating and the upper coating is at least 20 wt %. Further disclosed is a coated substrate, and a method for coating a substrate. The method for coating a substrate may further comprise: coating a clear coating composition on at least a portion of the upper coating to form a clear coating layer.

### TECHNICAL FIELD

The present disclosure relates to the field of coatings, in particular to a coating system, specifically a coating system suitable for a multi-coating one-baking process.

### BACKGROUND ART

In the field of coatings, multi-layer coatings may be formed by adopting a one-coating one-baking or multi-coating one-baking process. Compared with the one-coating one-baking process in which once a layer is coated, the layer will be baked, the so-called multi-coating one-baking refers to omitting intermediate baking steps and baking two or more coatings simultaneously after coating them.

In consideration of energy saving and economy, the multi-coating one-baking process is increasingly favored by the market. However, the multi-coating one-baking process is also prone to causing miscibility between coatings, leading to a poor appearance and reduced mechanical properties of the entire coating system. Therefore, how to meet the appearance and performance requirements for coatings while pursuing energy saving and economic benefits is a technical difficulty, which is especially challenging for automotive coatings and other application fields with high appearance requirements.

Moreover, automobile manufacturers favor the metallic color effect that imitates electroplated silver and has good aluminum powder orientation and low spark. The miscibility between coatings caused by the multi-coating one-baking application directly affects the arrangement of aluminum powder, which also brings negative effects on the realization of this color effect.

### SUMMARY

A multi-coating one-baking process is disclosed, and is capable of meeting the requirements for appearance and mechanical properties of coatings in automotive coatings and other application fields.

The present disclosure provides a coating system, comprising: a lower coating formed from a first coating composition, and an upper coating formed from a second coating composition including an effect pigment, the first coating composition and the second coating composition being cured simultaneously, wherein the upper coating has a dry film thickness of 3-20 μm, and a difference between foil solid contents of the lower coating and the upper coating is at least 20 wt %.

The present disclosure further discloses a coated substrate, comprising a substrate and the above-mentioned coating system coated on at least a portion of the substrate.

The present disclosure also discloses a method for coating a substrate, comprising:
coating the substrate with a first coating composition to form a lower coating;
coating a second coating composition on at least a portion of the lower coating to form an upper coating, the second coating composition including an effect pigment; and
curing the first coating composition and the second coating composition simultaneously, wherein the upper coating has a dry film thickness of 3-20 μm, and a difference between foil solid contents of the lower coating and the upper coating is at least 20 wt %.

The present disclosure also discloses a method for coating a substrate, comprising:
coating the substrate with a first coating composition to form a lower coating;
coating a second coating composition on at least a portion of the lower coating to form an upper coating, the second coating composition including an effect pigment;
coating a clear coating composition on at least a portion of the upper coating to form a clear coating; and
curing the first coating composition, the second coating composition and the clear coating composition simultaneously, wherein the upper coating has a dry film thickness of 3-20 μm, and a difference between foil solid contents of the lower coating and the upper coating is at least 20 wt %.

The features and advantages of the present disclosure will be demonstrated in detail in the following detailed description.

### DETAILED DESCRIPTION

In the present application, unless expressly stated otherwise, the singular includes the plural and the plural includes the singular in use. For example, although reference is made herein to “a” resin, one or more of these substances may be used.

In the present application, the terms “comprising”, “including”, “containing” and the like are not intended to limit the present disclosure to exclude any variant or addition. In addition, although the present disclosure has described coating compositions, preparation methods, etc. with terms such as “comprising”, the coating compositions, preparation methods, etc. described in detail herein may also be described as “essentially consisting of . . . ” or “consisting of . . . ”. In this case, “essentially consisting of . . . ” means that any additional ingredients will not materially affect the characteristics of coatings formed from the coating compositions.

In the present application, unless expressly stated otherwise, “or” is used to represent “and/or”, even though “and/or” may be explicitly used in some cases. In addition, any numerical range recited herein is intended to comprise all subranges subsumed therein. For example, a range of “1 to 10” is intended to comprise all subranges between the recited minimum value of 1 and the recited maximum value of 10 (inclusive), i.e., all subranges having a minimum value equal to or greater than 1 and a maximum value equal to or less than 10.

Except those in the examples or otherwise expressly stated, all values representing quantities of ingredients, etc. used in the specification and claims are to be construed as variable in all cases in accordance with the term “about”. Therefore, unless stated to the contrary, the numerical parameters listed in the following specification and claims are approximations and may vary according to the desired properties of the present disclosure. At the very least, not to limit the application of the doctrine of equivalents to the scope of the claims, each numerical parameter should at least be interpreted in terms of at least a significant number and by applying ordinary rounding techniques.

Notwithstanding that the numerical ranges and parameters representing the wide range of the present disclosure are approximations, the numerical values listed in specific examples are recorded as precisely as possible. Any numerical value, however, inherently possesses certain errors, which is the inevitable result of the standard deviation obtained in their respective measurement methods.

The present disclosure relates to a coating system, comprising: a lower coating formed from a first coating composition, and an upper coating formed from a second coating composition including an effect pigments, the first coating composition and the second coating composition being cured simultaneously, wherein the upper coating has a dry film thickness of 3-20 μm, and a difference between foil solid contents of the lower coating and the upper coating is at least 20 wt %.

Through the coordination between the upper coating and the lower coating, miscibility between different coatings under a multi-coating one-baking process is avoided, and the orientation of the effect pigment is prevented from being unfavorably interfered by adjacent coatings, thereby ensuring that the coating system has excellent appearance effects and mechanical properties. The upper coating has a lower dry film thickness, which is conducive to obtaining a high FI value (flip-flop index); in addition, the significant difference in foil solid content between the lower coating and the upper coating enables moisture to migrate quickly from the upper coating to the lower coating after application, which helps to rapidly increase the viscosity of the upper coating and assists in the arrangement of the effect pigment, thereby obtaining a higher FI value.

Herein, said “curing simultaneously” refers to that the first coating composition and the second coating composition are cured to form film simultaneously, and the first coating composition is not cured while the second coating composition is coated. Said “curing” refers to that at least a part of the ingredients in the coating composition is polymerized and/or cross-linked, or dried to form a hardened coating film.

Suitably, the first coating composition and the second coating composition and optionally one or more other coating compositions may be cured simultaneously. Said other coating compositions may form a coating located under the lower coating, and/or a coating located over the upper coating.

Suitably, the first coating composition and the second coating composition may be cured by heating. For example, the first coating composition and the second coating composition may be cured at 140° C. for 20 minutes. Said “curable” refers to that after baking at 140° C. for 20 minutes, the formed coating has a MEK double rub value of at least 50 times, suitably even at least 100 times.

As would be appreciated by those skilled in the art, the multi-coating one-baking process may comprise: performing flash drying to each coating coated. For example, after the first coating composition is coated and before the second coating composition is coated, flash drying is performed to the lower coating formed from the first coating composition. Said “flash drying” is a process of evaporating the solvent in the coating composition. Suitably, flash drying may be independently performed to the first coating composition, the second coating composition, and/or optionally one or more other coating compositions at room temperature (e.g., 23° C.) for 1-15 minutes.

Herein, said “dry film thickness” refers to a thickness of the coating formed from the coating composition after complete curing. Said “dry film thickness” may be obtained through measurement with a commercially available film thickness meter.

The upper coating may have a dry film thickness of 3-20 μm. For example, the upper coating may have a dry film thickness of 3 μm or more, 4 μm or more, 5 μm or more, and/or a dry film thickness of 20 μm or less, 19 μm or less, 18 μm or less, 17 μm or less, 16 μm or less, 15 μm or less, 14 μm or less, 13 μm or less, 12 μm or less, such as 11 μm, 10 μm, 9 μm, 8 μm, 7 μm, or 6 μm.

The lower coating may have a dry film thickness of 5-20 μm. For example, the lower coating may have a dry film thickness of 5 μm or more, 6 μm or more, 7 μm or more, 8 μm or more, and/or a dry film thickness of 20 μm or less, 18 μm or less, 16 μm or less, 14 μm or less, 12 μm or less, 10 μm or less.

Herein, said “foil solid content” refers to the solid content in the coating formed from the coating composition coated on a surface and having undergone flash drying. Said “foil solid content” is associated with the content of solids contained in the coating composition and the drying speed of the coating. A test method of said “foil solid content” is described in detail in the section of examples below.

The difference between foil solid contents of the lower coating and the upper coating may be at least 20 wt %, that is, the difference of the foil solid content of the lower coating minus the foil solid content of the upper coating is at least 20 wt %. Suitably, the difference between foil solid contents of the lower coating and the upper coating may be at least 25 wt %. Suitably, the difference between foil solid contents of the lower coating and the upper coating may be at least 30 wt %. Suitably, the difference between foil solid contents of the lower coating and the upper coating may be at least 35 wt %. Suitably, the difference between foil solid contents of the lower coating and the upper coating may be at least 40 wt %. Suitably, the difference between foil solid contents of the lower coating and the upper coating may be at least 45 wt %. Suitably, the difference between foil solid contents of the lower coating and the upper coating may be at least 50 wt %.

For example, the lower coating may have a foil solid content of 50 wt % or more, such as a foil solid content of 55 wt % or more, a foil solid content of 60 wt % or more, a foil solid content of 65 wt % or more, or a foil solid content of 70 wt % or more. Herein, the foil solid content of the lower coating is determined and obtained under a dry film thickness of 5-20 μm.

For example, the upper coating may have a foil solid content of 30 wt % or less, such as a foil solid content of 25 wt % or less, or a foil solid content of 20 wt % or less. Herein, the foil solid content of the upper coating is determined and obtained under a dry film thickness of 3-20 μm.

Suitably, the first coating composition forming the lower coating may have a higher solid content than the second coating composition forming the upper coating. Said “solid content” refers to the content of solids in the coating composition, which may be obtained by determining a ratio of the weight of the coating composition after the solvent has completely evaporated to the total weight of the coating composition.

Suitably, the first coating composition may have a solid content of 30-45 wt %, such as a solid content of 30-40 wt %. Suitably, the second coating composition may have a solid content of 8-20 wt %, such as a solid content of 8-16 wt %.

The second coating composition forming the upper coating may comprise an effect pigment. The effect pigments refer to pigments providing metallic effects for the coating, which may comprise aluminum powder pigments and/or mica powder pigments. The effect pigment may comprise surface-treated and/or non-surface-treated effect pigments. The non-surface-treated effect pigment may be pre-coated with a passivator before use.

Suitably, the effect pigment may comprise a silver dollar type effect pigment, such as silver dollar type aluminum powder. The silver dollar type effect pigment refers to a plate-like effect pigment having a silver dollar form. Suitably, the effect pigment may have an aspect ratio of 50:1 to 200:1, such as an aspect ratio of 70:1 to 200:1, for example, an aspect ratio of 100:1 to 200:1. Said “aspect ratio” refers to a ratio of the diameter to the thickness of the pigment.

Suitably, the effect pigment may have a WCA greater than 30,000 cm²/g. WCA refers to the area of aluminum powder covering water, i.e., the area of each gram of aluminum powder when the aluminum powder is located on the surface of water via a single layer of particles and no gap is visible between the particles. The WCA may be determined according to the GB/T 3173-1982 standard.

To obtain higher FI values, the effect pigment may comprise a pigment having narrow particle size distribution. The particle size distribution can be represented in a metric form as a cumulative particle size distribution curve, in which the percentage of particles smaller than a determined size is respectively derived. For example, D10 (a particle size corresponding to the cumulative particle size distribution percentage reaching 10%), D50 (a particle size corresponding to the cumulative particle size distribution percentage reaching 50%) and D90 (a particle size corresponding to the cumulative particle size distribution percentage reaching 90%). Herein, narrow particle size distribution may be characterized by calculating a particle size span, i.e., (D90−D10)/D50. Suitably, the effect pigment may have a particle size span of less than 1.5.

To achieve a desired spark effect, the effect pigment may have an average particle size of 5-25 μm, suitably an average particle size of 5-20 μm, such as an average particle size of 5-15 μm, and even an average particle size of 5-10 μm. Herein, the particle size may be obtained by measurement with a commercially available particle size analyzer.

The second coating composition may further comprise other pigments, and said other pigments refer to pigments other than the above-mentioned effect pigment. Pigments suitable for use in the second coating composition may include inorganic pigments, such as carbon black, titanium white, and iron red, and/or organic pigments, such as azo pigments, phthalocyanine pigments, and perylene pigments.

In the second coating composition, the content of pigments (effect pigments and optionally other pigments) may be represented by a pigment-binder ratio. Said “pigment-binder ratio (P/B)” refers to a solid weight ratio of the pigment (effect pigment and optionally other pigments) in the second coating composition to the binder in the second coating composition. Suitably, the second coating composition has a pigment-binder ratio of 0.02:1 to 0.3:1, such as a pigment-binder ratio of 0.02:1 to 0.1:1.

The coating system may have a high FI value. Suitably, the coating system may have an FI value of at least 20. A method for determining the FI value is described in detail in the section of examples below.

The coating system may have a low G value. The G value represents the spark intensity of the coating, wherein: the smaller the G value is, the weaker the spark is; and the larger the G value is, the stronger the spark is. Suitably, the coating system may have a G value of not more than 6. A method for determining the G value are described in detail in the section of examples below.

The coating system may have a low VOC content. Suitably, each of the first coating composition and the second coating composition in the coating system may have a VOC content of less than 420 g/L. The VOC value is measured without water, which may be obtained by detecting the content of each organic compound component in the first coating composition or the second coating composition by employing gas chromatography, and then adding up the contents of all components.

In addition, the structural characteristics of the lower coating may cause the lower coating to form a stable coating film, which reduces the intrusion of the lower coating by the organic solvent in the upper coating, thereby further avoiding the miscibility between different coatings under the multi-coating one-baking process, so that the lower coating does not interfere with the arrangement of aluminum powder in the upper coating, nor does it adversely reduce the mechanical properties of each coating. At the same time, the structural characteristics of the upper coating also cause the upper coating to be free from interference in the arrangement of effect pigment induced by the intrusion of organic solvent in the coating above it (such as in the clear coating), thereby obtaining higher FI value and achieving qualified mechanical properties.

### First Coating Composition

The lower coating in the coating system may be formed from the first coating composition. The first coating composition may be a waterborne coating composition. Herein, “waterborne” means that the solvent of the coating composition contains at least 50 wt % water.

The first coating composition may be a one-component coating composition. Said “one-component” represents that all film-forming resins (i.e., binder), pigments and fillers, solvents and/or additives, etc. of the coating composition are packaged in one container, thus having the advantages of convenient storage and use, etc.

In the first coating composition, the viscosity of the film-forming resins increases rapidly after curing, thereby minimizing the inference between the lower coating formed from the first coating composition and other coatings (such as the upper coating formed from the second coating composition). The film-forming resins affect the structural characteristics of the formed coating and provide the coating system with desirable mechanical properties, such as stone chip resistance, impact resistance, cupping, moisture resistance, UV radiation resistance, etc.

In the first coating composition, the film-forming resin may comprise an acrylic resin, an acrylate grafted polyurethane resin, a polyurethane resin, and/or a melamine formaldehyde resin, wherein the acrylic resin, the acrylate grafted polyurethane resin, the polyurethane resin, and/or the melamine formaldehyde resin are different from each other. Suitably, the film-forming resin comprises at least a polyurethane resin. For example, the film-forming resins may comprise a polyurethane resin, an acrylic resin, and/or an acrylate grafted polyurethane resin, and a melamine formaldehyde resin. The acrylic resin and/or acrylate grafted polyurethane resin coordinates with the polyurethane resin to form a stable coating structure and enhance the mechanical properties of the coating. Suitably, a weight ratio of the polyurethane resin to the acrylic resin and/or acrylate grafted polyurethane resin, i.e., the weight of the polyurethane resin/(the weight of the acrylic resin and/or acrylate grafted polyurethane resin), may be 0.1-0.9.

The polyurethane resin refers to a polymer whose repeating unit comprises polyurethane groups. The polyurethane may comprise a polymer with at least 50 wt % of organic units, for example, at least 70 wt %, such as at least 90 wt % of organic units linked through carbamate bonds. Herein, the organic units comprise one or more residues selected from the following: simple diols, polyester diols, polyether diols, and polycarbonate diols.

The polyurethane resin may be prepared by polyisocyanate and polyol. Suitably, the polyisocyanate comprises one or more of the following: aromatic isocyanate, aliphatic isocyanate, and alicyclic isocyanate.

Suitably, the polyurethane resin may have a weight-average molecular weight (Mw) of 2,000-200,000, such as a weight-average molecular weight of 10,000-150,000. The weight-average molecular weight may be determined by gel permeation chromatography using appropriate standards, such as a polystyrene standard. Suitably, the polyurethane resin may have an average particle size of 100-2,000 nm, such as an average particle size of 200-1,500 nm. The particle size may be measured by laser diffractometry.

Suitably, the polyurethane resin may be in the form of dispersion or emulsion, which has a solid fraction of 20-60 wt %. Said “solid fraction” refers to a percentage of mass representing the mass remaining after evaporation of solvent in the dispersion/emulsion to the original dispersion/emulsion. The polyurethane dispersion/emulsion has good stability and film-forming property, and has good chemical resistance and flexibility after film formation.

Based on the total weight of the first coating composition, the polyurethane resin may be at least 1 wt %, suitably at least 2 wt %, such as at least 3 wt %, and/or at most 10 wt %, suitably at most 8 wt %, such as at most 5 wt %. Based on the total weight of the first coating composition, the polyurethane resin may be present in the coating composition in a range of 1-10 wt %, suitably 2-8 wt %, such as 3-5 wt %, or any other combinations using these end values.

The acrylic resin refers to a polymer with (meth)acrylic monomers as a basic component. Said “basic component” refers to that the (meth)acrylic monomers in the polymer account for at least 70 wt %, for example, at least 80 wt %, such as at least 90 wt %, of all polymeric monomers.

Suitably, the acrylic resin may have a hydroxyl value of 50-150 mgKOH/g, such as a hydroxyl value of 70-120 mgKOH/g. The hydroxyl value refers to a number of milligrams of potassium hydroxide (KOH) equivalent to the hydroxyl groups in 1 gram of resin. Suitably, the acrylic resin may have an acid value of 1-50 mgKOH/g, such as an acid value of 10-40 mgKOH/g. The acid value refers to a number of milligrams of potassium hydroxide required to neutralize free acids in 1 gram of resin. Suitably, the acrylic resin may have an average particle size of 100-1000 nm, such as an average particle size of 100-800 nm. The particle size may be measured by laser diffractometry.

Suitably, the acrylic resin may be in the form of a dispersion or emulsion, which has a solid fraction of 20-60 wt %. Said “solid fraction” refers to a percentage of mass representing the mass remaining after evaporation of solvent in the dispersion/emulsion to the original dispersion/emulsion. Suitably, the acrylic dispersion/emulsion has a viscosity of 100-1,000 mPa at room temperature, wherein room temperature refers to 15-30° C. Herein, the viscosity may be obtained by measurement with a commercially available viscometer. The acrylic resin dispersion/emulsion provides good viscoelasticity, film-forming property and stability.

Based on the total weight of the first coating composition, the acrylic resin may be at least 3 wt %, suitably at least 4 wt %, such as at least 5 wt %, and/or at most 15 wt %, suitably at most 12 wt %, such as at most 8 wt %. Based on the total weight of the first coating composition, the acrylic resin may be present in the coating composition in a range of 3-15 wt %, suitably 4-12 wt %, such as 5-8 wt %, or any other combinations using these end values.

The acrylate grafted polyurethane resin refers to a polyurethane resin having a branched chain containing an acrylic group, and at least 50 wt % of the organic units in the polyurethane resin are linked through carbamate bonds.

Suitably, the acrylate grafted polyurethane resin may have a weight-average molecular weight (Mw) of 2,000-200,000, such as a weight-average molecular weight of 10,000-150,000.

The weight-average molecular weight may be determined by gel permeation chromatography using appropriate standards, such as a polystyrene standard. Suitably, the acrylate grafted polyurethane resin may have a hydroxyl value of 10-100 mgKOH/g, such as a hydroxyl value of 20-80 mgKOH/g. The hydroxyl value refers to a number of milligrams of potassium hydroxide (KOH) equivalent to the hydroxyl groups in 1 gram of resin. Suitably, the acrylate grafted polyurethane resin may have an acid value of 1-50 mgKOH/g, such as an acid value of 10-40 mgKOH/g. The acid value refers to a number of milligrams of potassium hydroxide required to neutralize free acids in 1 gram of resin. Suitably, the acrylate grafted polyurethane resin may have an average particle size of 100-2,000 nm, such as an average particle size of 500-1,500 nm. The particle size may be measured by laser diffractometry.

Suitably, the acrylate grafted polyurethane resin may be in the form of a dispersion or emulsion, which has a solid fraction of 20-60 wt %. Said “solid fraction” refers to a percentage of mass representing the mass remaining after evaporation of solvent in the dispersion/emulsion to the original dispersion/emulsion. The acrylate grafted polyurethane dispersion/emulsion has good compatibility with other components, and has better stability and chemical resistance after film formation.

Based on the total weight of the first coating composition, the acrylate grafted polyurethane resin may be at least 5 wt %, suitably at least 8 wt %, such as at least 10 wt %, and/or at most 30 wt %, suitably at most 20 wt %, such as at most 15 wt %. Based on the total weight of the first coating composition, the acrylate grafted polyurethane resin may be present in the coating composition in a range of 5-30 wt %, suitably 8-20 wt %, such as 10-15 wt %, or any other combinations using these end values.

The film-forming resin in the first coating composition may further comprise a melamine formaldehyde resin. The melamine formaldehyde resin may be cross-linked with the above polyurethane resin, acrylic resin, and/or acrylate grafted polyurethane resin to improve the film-forming property of the first coating composition and accelerate curing. The melamine formaldehyde resin may be one kind of melamine formaldehyde resin or a combination of multiple different melamine formaldehyde resins. In the melamine formaldehyde resin or the combination of melamine formaldehyde resins, a functional group ratio of the sum of imino group and hydroxymethyl group to alkoxy group in the melamine formaldehyde resin is 5:80 to 50:50.

Based on the total weight of the first coating composition, the melamine formaldehyde resin may be at least 5 wt %, suitably at least 10 wt %, and/or at most 25 wt %, for example at most 20 wt %. Based on the total weight of the first coating composition, the melamine formaldehyde resin may be present in the coating composition in a range of 5-25 wt %, suitably 10-20 wt %, or any other combinations using these end values.

The first coating composition may further comprise a pigment. The pigment provides desired color and/or hiding power for the lower coating, thereby affecting the appearance of the coating system. The pigment may be any pigment suitable for a waterborne coating composition. Suitably, the pigment includes carbon black, titanium white, iron oxide red, and/or perylene red, and other inorganic or organic pigments, to form a dark-colored lower coating with high hiding power. Herein, “dark-colored” represents that a brightness value (45° L value) of the lower coating is not more than 80 based on an L*a*b color system specified in JIS Z 8729.

Suitably, the pigment may be in the form of color paste, which has a solid fraction of 10-45 wt %. Typically, the first coating composition may comprise 5-35 wt % of color paste based on the total weight of the first coating composition.

The first coating composition may also comprise 30%-50% of water based on the total weight of the first coating composition.

The first coating composition may further comprise one or more other auxiliary ingredients as follows: an organic co-solvent, a wetting additive, a pinhole additive, a curing catalyst, a defoamer, an ultraviolet absorber, a light stabilizer, an adhesion promoter, a surface leveling agent, a pH regulator, a substrate wetting agent, a thickener, a filler and the like. When these auxiliary ingredients are present, each auxiliary component is present in an amount of at most 10 wt % based on the total weight of the first coating composition.

### Second Coating Composition

The upper coating in the coating system may be formed from the second coating composition. The second coating composition may be a waterborne coating composition. The second coating composition may be a one-component coating composition.

The film-forming resin in the second coating composition may include a high Tg acrylic resin and a high Tg polyurethane resin, wherein the high Tg acrylic resin and the high Tg polyurethane resin are different from each other. Suitably, a weight ratio of the high Tg acrylic resin to the high Tg polyurethane resin may be 10-80:5-50, such as 30-50:10-30. The combination of the high Tg acrylic resin and the high Tg polyurethane resin forms a dense and stable coating structure, which reduces the penetration of organic solvent of other coatings; and the selection of the film-forming resin imparts mechanical properties to the coating, so that various application needs may also be met at low film thicknesses, meanwhile, the orientation of the effect pigment in the second coating composition is facilitated.

The acrylic resin refers to a polymer with (meth)acrylic monomers as a basic component. Said “basic component” means that the (meth)acrylic monomers in the polymer account for at least 70 wt %, for example, at least 80 wt %, such as at least 90 wt %, of all polymeric monomers.

The high Tg acrylic resin may have a glass transition temperature (Tg) greater than 40° C., suitably a glass transition temperature of 40-150° C. The glass transition temperature may be measured by dynamic thermomechanical analysis (DMA) using TA Instruments Q800 instrument, with the following measurement parameters: 10 Hz in frequency, 5 mm in amplitude, −100° C. to 250° C. in temperature ramp, and Tg determined as a peak value of tan δ curve according to ASTM D7028.

Suitably, the high Tg acrylic resin may have a hydroxyl value of 10-100 mgKOH/g, such as a hydroxyl value of 20-80 mgKOH/g. The hydroxyl value refers to a number of milligrams of potassium hydroxide (KOH) equivalent to the hydroxyl groups in 1 gram of resin. Suitably, the high Tg acrylic resin may have an acid value of 1-70 mgKOH/g, such as an acid value of 10-50 mgKOH/g. The acid value refers to a number of milligrams of potassium hydroxide required to neutralize free acids in 1 gram of resin. Suitably, the high Tg acrylic resin may have an average particle size of 100-1,000 nm, such as an average particle size of 100-800 nm. The particle size may be measured by laser diffractometry.

Suitably, the high Tg acrylic resin may be in the form of a dispersion or emulsion, which has a solid fraction of 20-60 wt %. Said “solid fraction” refers to a percentage of mass representing the mass remaining after evaporation of the solvent in the dispersion/emulsion to the original dispersion/emulsion. The dispersion/emulsion of the high Tg acrylic resin has good film-forming property and dries quickly.

Based on the total weight of the second coating composition, the high Tg acrylic resin may be at least 2 wt %, suitably at least 3 wt %, such as at least 4 wt %, and/or at most 15 wt %, suitably at most 10 wt %, such as at most 8 wt %. Based on the total weight of the second coating composition, the high Tg acrylic resin may be present in the coating composition in a range of 2-15 wt %, suitably 3-10 wt %, such as 4-8 wt %, or any other combinations using these end values.

The polyurethane resin refers to a polymer whose repeating unit comprise polyurethane groups. The polyurethane may comprise a polymer with at least 50 wt % of organic units, for example, at least 70 wt %, such as at least 90 wt % of organic units linked through carbamate bonds. Herein, the organic unit comprises one or more residues selected from the following: simple diols such as butanediols, polyester diols, polyether diols, and polycarbonate diols.

The high Tg polyurethane resin may have a glass transition temperature (Tg) greater than 30° C., suitably a glass transition temperature of 30-70° C. The glass transition temperature may be measured by dynamic thermomechanical analysis (DMA) using TA Instruments Q800 instrument, with measurement parameters: 10 Hz in frequency, 5 mm in amplitude, −100° C. to 250° C. in temperature ramp, and Tg determined as a peak value of tan δ curve according to ASTM D7028.

Suitably, the high Tg polyurethane resin may have a weight-average molecular weight (Mw) of 2,000-15,000, such as a weight-average molecular weight of 5,000-12,000. The weight-average molecular weight may be determined by gel permeation chromatography using appropriate standards, such as a polystyrene standard.

Suitably, the high Tg polyurethane resin may be in the form of a dispersion or emulsion, which has a solid fraction of 20-60 wt %. Said “solid fraction” refers to a percentage of mass representing the mass remaining after evaporation of solvent in the dispersion or emulsion to the original dispersion or emulsion. The dispersion or emulsion of the high Tg polyurethane has high drying speed and good chemical resistance after film formation.

Based on the total weight of the second coating composition, the Tg polyurethane resin may be at least 1 wt %, suitably at least 2 wt %, such as at least 3 wt %, and/or at most 18 wt %, suitably at most 15 wt %, such as at most 10 wt %. Based on the total weight of the second coating composition, the high Tg polyurethane resin may be present in the coating composition in a range of 1-18 wt %, suitably 2-15 wt %, such as 3-10 wt %, or any other combinations using these end values.

The film-forming resin in the second coating composition may further comprise a polyester resin. The polyester resin refers to a polymer generated by polyesterification of polyols and polyacids, wherein the polyols is a compound containing two or more hydroxyl groups per molecule, and the polyacids is a compound containing two or more carboxyl groups per molecule.

Suitably, the polyester resin may have a hydroxyl value of 10-100 mgKOH/g, such as a hydroxyl value of at least 20-80 mgKOH/g. The hydroxyl value refers to a number of milligrams of potassium hydroxide (KOH) equivalent to the hydroxyl groups in 1 gram of resin. Suitably, the polyester resin may have an acid value of 1-100 mg KOH/g, such as an acid value of 10-70 mg KOH/g. The acid value refers to a number of milligrams of potassium hydroxide required to neutralize free acids in 1 gram of resin.

Based on the total weight of the second coating composition, the polyester resin may be at least 0.1 wt %, suitably at least 0.5 wt %, and/or at most 5 wt %, suitably at most 3 wt %. Based on the total weight of the second coating composition, the polyester resin may be present in the coating composition in a range of 0.1-5 wt %, suitably 0.5-3 wt %, or any other combinations using these end values.

The film-forming resin in the second coating composition may further comprise a melamine formaldehyde resin. The melamine formaldehyde resin may be cross-linked with the above high Tg acrylic resin, high Tg polyurethane resin and/or polyester resin to improve the film-forming property of the second coating composition and accelerate curing. The melamine formaldehyde resin may be one kind of melamine formaldehyde resin or a combination of multiple different melamine formaldehyde resins. In the melamine formaldehyde resin or the combination of melamine formaldehyde resins, a functional group ratio of the sum of imino groups and hydroxymethyl groups to alkoxy groups in the melamine formaldehyde resin is 5:80 to 50:50.

Based on the total weight of the second coating composition, the melamine formaldehyde resin may be at least 1 wt %, suitably at least 3 wt %, and/or at most 15 wt %, for example at most 10 wt %. Based on the total weight of the second coating composition, the melamine formaldehyde resin may be present in the coating composition in a range of 1-15 wt %, suitably 3-10 wt %, or any other combinations using these end values.

The second coating composition may further comprise a pigment. The pigment comprises an effect pigment and optionally other pigments. Suitably, the pigment may be in the form of a color paste, which has a solid fraction of 10-45 wt %. Typically, the second coating composition may comprise 1-30 wt % of color paste based on the total weight of the second coating composition.

The second coating composition may further comprise a thickener. The thickener may effectively improve low-shear rate viscosity, so that the formed coating has high shear dilution characteristic, thereby being capable of ensuring excellent storage stability and workability and avoiding fat edge. Suitably, the thickener may comprise one or more of the following: a silicate thickener, an acrylic thickener, a polyurethane thickener, a polyamide wax thickener, and a polyurea thickener. Suitably, the thickener comprises a silicate thickener. When the silicate thickener and other thickeners are used at the same time, a weight ratio of the silicate thickener to the other thickeners may be 0.2:1 to 5:1, suitably 0.5:1 to 2:1. Based on the total weight of the second coating composition, the thickener may be 0.01-5 wt %.

The second coating composition may further comprise 40-70 wt % of water based on the total weight of the second coating composition.

The second coating composition may further comprise one or more other auxiliary ingredients as follows: an organic co-solvent, a wetting additive, a pinhole additive, a curing catalyst, a defoamer, an ultraviolet absorber, a light stabilizer, an adhesion promoter, a surface leveling agent, a pH regulator, a substrate wetting agent, a filler and the like. When these auxiliary ingredients are present, each auxiliary component is present in an amount of at most 10 wt % based on the total weight of the second coating composition.

The present disclosure further provides a coated substrate, comprising a substrate and the above-mentioned coating system coated on at least a portion of the substrate. Suitably, the substrate may comprise a metal. The substrate may be pretreated, unpretreated, precoated, and/or unprecoated.

The lower coating in the coating system may be obtained by applying the first coating composition by any standard method known in the art. The upper coating in the coating system may be obtained by applying the second coating composition by any standard method known in the art. Standard methods known in the art include, but are not limited to, spraying, dipping, rolling, brushing, and the like.

The present disclosure also provides a method for coating a substrate, comprising:
coating the substrate with a first coating composition to form a lower coating;
coating a second coating composition on at least a portion of the lower coating to form an upper coating, the second coating composition including an effect pigment; and
curing the first coating composition and the second coating composition simultaneously, wherein the upper coating has a dry film thickness of 3-20 μm, and the difference between foil solid contents of the lower coating and the upper coating is at least 20 wt %.

Suitably, the substrate may comprise a metal. The substrate may be pretreated, unpretreated, precoated, and/or unprecoated. Suitably, the curing is performed by heating, e.g., baking at 140° C. for 20-60 minutes.

Suitably, the method for coating a substrate according to the present disclosure further comprises: coating one or more coating compositions on at least a portion of the upper coating to form one additional coating or multiple additional coatings. The one or more coating compositions may include a clear coating composition.

Therefore, the method for coating a substrate comprises:
coating the substrate with a first coating composition to form a lower coating;
coating a second coating composition on at least a portion of the lower coating to form an upper coating, the second coating composition including an effect pigment;
coating one or more coating compositions on at least a portion of the upper coating to form one additional coating or multiple additional coatings; and
curing the first coating composition, the second coating composition and the one or more coating compositions simultaneously, wherein the upper coating has a dry film thickness of 3-20 μm, and the difference between foil solid contents of the lower coating and the upper coating is at least 20 wt %.

Suitably, the method for coating a substrate according to the present disclosure further comprises: performing flash drying to the lower coating, the upper coating, and optionally the one additional coating or multiple additional coatings, respectively. Suitably, the flash drying may be performed at room temperature (e.g., 23° C.) for 1-15 minutes. Suitably, the method for coating a substrate according to the present disclosure further comprises: performing pre-baking after the upper coating is formed. Suitably, the pre-baking may be performed at 70-90° C. for 1-10 minutes, for example, 80° C.*5 minutes.

### EXAMPLES

The following examples are provided to further illustrate the present disclosure, but should not be construed as limiting the disclosure to the details described in the examples. Unless otherwise specified, all factions and percentages in the following examples are measured by weight.

### First Coating Composition

Ingredients and contents listed in the following table are used to prepare the first coating composition of examples (Ex 1-3) and comparative examples (CE 1-2), and the specific steps are: (1) adding the acrylic resin, the acrylate grafted polyurethane resin and the polyurethane resin into a reactor at room temperature (e.g., 23° C.) under stirring conditions in turn; (2) adding part of the pH regulating additive to adjust the PH value of the mixture described in step (1) to 8.2-8.7, and adding appropriate deionized water to adjust the system viscosity to 150~200 mPa·s at 1000 s⁻¹; (3) adding the organic solvent, the wetting additive, the pinhole additive, the melamine formaldehyde resin, the color paste, and the filler paste in the mixture described in step (2) under stirring; (4) adding the remaining pH regulating additive to adjust the PH of the system to 8.2-8.7, and adding the remaining deionized water to adjust the viscosity to 60~80 mPa·s at 1000 s⁻¹.

TABLE 1
First coating composition

| | | | | Compar- | Compar- |
|---|---|---|---|---|---|
| | Exam- | Exam- | Exam- | ative | ative |
| Ingredients | ple 1 | ple 2 | ple 3 | Example 1 | Example 2 |
| Acrylate grafted | 20 | | 22 | | |
| polyurethane | | | | | |
| resin (A)^{a} | | | | | |
| Acrylate grafted | | | | 12 | 3 |
| polyurethane | | | | | |
| resin(B)^{b} | | | | | |
| Polyurethane^{c} | 10 | 10 | 6 | | |
| Acrylic resin | | 15 | 13 | | |
| (A)^{d} | | | | | |
| Acrylic resin (B)^{e} | | | | 10 | 13 |
| Melamine | 8 | 10 | 8 | 8 | 5 |
| formaldehyde | | | | | |
| resin^{f} | | | | | |
| Organic solvent^{g} | 4 | 4 | 3 | 4 | 4 |
| Color paste^{h} | 10 | 10 | 9 | 10 | 25 |
| Filler pasteⁱ | 5 | 3 | 2 | 2 | 0 |
| Wetting additive^{j} | 0.5 | 0.5 | 1 | 0.5 | 1 |
| Pinhole additive^{k} | 2 | 1 | 0.5 | 2 | 1.5 |
| PH regulating | 0.5 | 1 | 0.5 | 0.5 | 0.5 |
| additive^{l} | | | | | |
| Deionized water | 40 | 45.5 | 35 | 51 | 47 |
| Foil solid content | 50% | 55% | 65% | 35% | 30% |
| (10 μm) | | | | | |

^{a}Have a solid fraction of 40-50 wt %, a weight-average molecular weight (Mw) of 2,000-200,000, a hydroxyl value of 10-100 mgKOH/g, an acid value of 1-50 mgKOH/g, and an average particle size of 100-2,000 nm;
^{b}Have a solid fraction of 30-40 wt %, a weight-average molecular weight (Mw) of 2,000-200,000, a hydroxyl value of 10-100 mgKOH/g, an acid value of 1-50 mgKOH/g, and an average particle size of 100-2,000 nm;
^{c}Have a solid fraction of 35-45 wt %, a weight-average molecular weight (Mw) of 10,000-150,000, and an average particle size of 200-1,500 nm;
^{d}Have a solid fraction of 35-45 wt %, a hydroxyl value of 50-150 mgKOH/g, an acid value of 1-50 mgKOH/g, and an average particle size of 100-1,000 nm;
^{e}Have a solid fractionof 20-35 wt %, a hydroxyl value of 50-150 mgKOH/g, an acid value of 1-50 mgKOH/g and an average particle size of 100-1,000 nm;
^{f}Have a solid fraction of 75-85 wt %, and a functional group ratio of the sum of imino group and hydroxymethyl group to alkoxy group of 5:80 to 50:50;
^{g}Alcohol and alcohol ether solvents;
^{h}Include titanium white, carbon black, and/or perylene red and other pigments;
ⁱBarium sulfate;
^{j}Commercially available from BYK;
^{k}Commercially available from BYK;
^{l}Commercially available from DOW.

### Second Coating Composition

Ingredients and contents listed in the following table are used to prepare the second coating composition of examples and comparative examples, and the specific steps are: (1) adding the acrylic resin, the acrylate grafted polyurethane resin and the polyester into a reactor at room temperature (e.g., 23° C.) under stirring conditions in turn; (2) adding part of the pH regulating additive to adjust the PH value of the mixture described in step (1) to 8.2-8.7, and adding appropriate deionized water to adjust the system viscosity to 150~200 mPa·s at 1000 s⁻¹; (3) adding part of the organic solvent, the wetting additive, the pinhole additive, the melamine formaldehyde resin, the color paste, and part of the thickener in the mixture described in step (2) under stirring; (4) mixing and stirring the aluminum powder, the passivator and the remaining solvent, etc., in another stirring tank to uniformly disperse the aluminum powder; (5) adding the mixture in step (4) into the mixture prepared in step (3) in turn under stirring conditions; (6) adding the remaining thickener into the mixture of step (5), adjusting the PH of the system to 8.2-8.7, and adding the remaining deionized water to adjust the viscosity to 60~80 mPa·s at 1000 s⁻¹.

TABLE 2
Second coating composition

| | Exam- | Exam- | Comparative | Comparative |
|---|---|---|---|---|
| Ingredients | ple 4 | ple 5 | Example 3 | Example 4 |
| Acrylic resin^{a} | 17 | 20 | 22 | 20.2 |
| Polyurethane(A)^{b} | 10 | 7 | | |
| Polyurethane(B)^{c} | | | | 8 |
| Polyester^{d} | 2 | 2 | 4.5 | 4 |
| Melamine formaldehyde | 4 | 3.5 | 3 | 4 |
| resin^{e} | | | | |
| Organic solvent^{f} | 3.5 | 3.5 | 8 | 4 |
| Color paste^{g} | 3 | 3 | 3 | 3 |
| Aluminum powder^{h} | 1 | 1 | 1 | 1 |
| Wetting additiveⁱ | 1 | 1 | 1 | 1 |
| Pinhole additive^{j} | 0.5 | 0.5 | 0.5 | 0.5 |
| Passivator^{k} | 0.2 | 0.2 | 0.2 | 0.2 |
| Thickener^{l} | 0.7 | 0.3 | 1.8 | 1.1 |
| PH regulating additive^{m} | 0.2 | 0.2 | 0.2 | 0.2 |
| Deionized water | 56.9 | 57.8 | 52.8 | 52.8 |
| Foil solid content (6 μm) | 23% | 28% | 25% | 25% |

^{a}Have a solid fraction 20-35 wt %, a glass transition temperature (Tg) of more than 40 °C, a hydroxyl value of 10-100 mgKOH/g, an acid value of 1-70 mgKOH/g, and an average particle size of 100-1,000;
^{b}Have a solid fraction of 30-40 wt %, a glass transition temperature (Tg) of 30-70 °C, and a weight-average molecular weight (Mw) of 2,000-15,000;
^{c}Have a solid fraction of 35-45 wt %, and a glass transition temperature (Tg) of −10-10 °C;
^{d}Have a solid fraction of 35-75 wt %, a hydroxyl value of 10-100 mgKOH/g, and an acid value of 1-100 mgKOH/g;
^{e}Have a solid fraction of 75-85 wt %, and a functional group ratio of the sum of imino group and hydroxymethyl group to alkoxy group of 5:80 to 50:50;
^{f}Alcohol and alcohol ether solvents;
^{g}Include titanium white, carbon black, and/or perylene red and other pigments;
^{h}Silver dollar type aluminum powder from Toyal;
ⁱCommercially available from BYK;
^{j}Commercially available from BYK;
^{k}Have an acid value of 20-200 mgKOH/g;
^{l}Include a silicate thickener and other thickeners selected from the following: an acrylic thickener, a polyurethane thickener, a polyamide wax thickener, and a polyurea thickener, the weight ratio of the silicate thickener to other thickeners being 0.2:1 to 5:1;
^{m}Commercially available from DOW;
ⁿCommercially available from BASF, Elementis, and BYK.

The foil solid contents of the first coating compositions and the second coating compositions described above were obtained by testing with the following method:
1. Taking a piece of foil paper;
2. Spraying the foil paper in a designated area with STD spraying parameters, the spraying environment: a temperature of 23° C., a humidity of 65%, a coating thickness of 10 μm (the first coating composition) or 6 μm (the second coating composition);
3. Performing flash drying at 23° C. for 3 minutes;
4. Baking at 140° C. for 30 minutes; and
5. Measuring the weight after baking and calculating a weight ratio of the weight after baking to the total weight of the coating composition used for spraying.

### Coating System

The coating system comprises the lower coating formed from the first coating composition and the upper coating formed from the second coating composition, and the specific preparation method comprises:
spraying the first coating composition on a metal substrate (pre-treated and pre-coated) to form the lower coating; performing flash drying to the lower coating at room temperature for at least 3 min; coating the second coating composition on at least a portion of the lower coating to form the upper coating; prebaking at 80° C. for at least 5 min; coating a clear coating composition (commercially available two-component clear coating composition) on at least a portion of the upper coating; and curing the first coating composition, the second coating composition and the clear coating composition simultaneously at 140° C.*20 min.

The following table shows the coating systems comprising the first coating compositions and the second coating compositions having different foil solid contents.

TABLE 3
Coating system

| | | Dry film | | Foil solid | Difference in foil |
|---|---|---|---|---|---|
| | | thickness | | content | solid content |
| Example 6 | Example 1 | 10 | um | 50% | 27% |
| | Example 4 | 6 | um | 23% | |
| Example 7 | Example 1 | 10 | um | 50% | 22% |
| | Example 5 | 6 | um | 28% | |
| Example 8 | Example 2 | 10 | um | 55% | 32% |
| | Example 4 | 6 | um | 23% | |
| Example 9 | Example 2 | 10 | um | 55% | 27% |
| | Example 5 | 6 | um | 28% | |
| Example 10 | Example 3 | 10 | um | 65% | 42% |
| | Example 4 | 6 | um | 23% | |
| Example 11 | Example 3 | 10 | um | 65% | 37% |
| | Example 5 | 6 | um | 28% | |
| Comparative | Comparative | 10 | um | 35% | 10% |
| | Example 1 | | | | |
| Example 5 | Comparative | 6 | um | 25% | |
| | Example 3 | | | | |
| Comparative | Comparative | 10 | um | 35% | 10% |
| | Example 1 | | | | |
| Example 6 | Comparative | 6 | um | 25% | |
| | Example 4 | | | | |
| Comparative | Comparative | 10 | um | 30% | 5% |
| | Example 2 | | | | |
| Example 7 | Comparative | 6 | um | 25% | |
| | Example 3 | | | | |
| Comparative | Comparative | 10 | um | 30% | 5% |
| | Example 2 | | | | |
| Example 8 | Comparative | 6 | um | 25% | |
| | Example 4 | | | | |

Note:
The difference in foil solid content is the foil solid content of the lower coating (the first coating composition) minus the foil film solid content of the upper coating (the second coating composition).

Note: The difference in foil solid content is the foil solid content of the lower coating (the first coating composition) minus the foil film solid content of the upper coating (the second coating composition).

### Property Tests:

The coating systems obtained from Examples 6-11 and Comparative Examples 5-8 were subjected to the following testing for various properties:

1—FI value:

It is related to the color brightness at each angle: the greater the FI value is, the greater the difference in color brightness between small angle and large angle is, and the closer the color simulates to a mirror effect.

Herein, brightness values (L) at 15°, 45° and 110° were tested by the commercially available BYK colorimeter, and then the FI value was calculated by the following formula.

F1=2.69*(L*₁₅−L*₁₁₀)^{1.11}/(L*₄₅)^{0.86}

### 2—G Value:

It represents the spark intensity of a color under a light source, the smaller the G value is, the lower the spark is, and the closer the color simulates to a fine mirror effect. Herein, the G value was obtained by testing with the commercially available BYK colorimeter.

TABLE 4
Property tests of coating systems - FI and G values

| | | FI | G |
|---|---|---|---|
| Example 6 | Example 1 | 22 | 5.3 |
| | Example 4 | | |
| Example 7 | Example 1 | 20 | 5.3 |
| | Example 5 | | |
| Example 8 | Example 2 | 21 | 5.3 |
| | Example 4 | | |
| Example 9 | Example 2 | 21 | 5.5 |
| | Example 5 | | |
| Example 10 | Example 3 | 23 | 5 |
| | Example 4 | | |
| Example 11 | Example 3 | 22 | 5.1 |
| | Example 5 | | |
| Comparative Example 5 | Comparative Example 1 | 17 | 6.3 |
| | Comparative Example 3 | | |
| Comparative Example 6 | Comparative Example 1 | 17 | 6.2 |
| | Comparative Example 4 | | |
| Comparative Example 7 | Comparative Example 2 | 13 | 8.2 |
| | Comparative Example 3 | | |
| Comparative Example 8 | Comparative Example 2 | 12 | 8.3 |
| | Comparative Example 4 | | |

Examples 1-3 have higher foil solid contents, and Comparative Examples 1-2 have lower foil solid contents. Therefore, Examples 1-3 and Examples 4-5 generate a larger difference in foil solid content (at least 20%), while Comparative Examples 1-2 and Comparative Examples 3-4 generate a relatively smaller difference in foil solid content. From the test results in the above table, it can be seen that the difference in foil solid content between the upper coating and the lower coating in Examples 6-11 is relatively large, thus the finally obtained FI value is at least 20, and the G value is lower; while the difference in foil solid content in Comparative Examples 5-8 is relatively small, so the obtained color has a lower FI value, and the G value is also higher.

### 3—VOC Content

Herein, the VOC (without water, g/L) contents of the first coating compositions and the second coating compositions were calculated by the following method:
1. Measuring the mass mi of each component in the composition, the mass mw of water in the composition, and the density ρₛ of the composition, respectively;
2. Calculating according to the following formula,

$${ρ ( VOC )}_{\text{?}} ( \begin{matrix}{\sum }_{\text{?}}^{\text{?}} {m}_{\text{?}} \\ 1 - {ρ}_{\text{?}} \times \frac{{m}_{\text{?}}}{{ρ}_{\text{?}}}\end{matrix} ) \times {ρ}_{\text{?}} \times 1 \; 000$$

$$\text{?} \text{indicates text missing or illegible when filed}$$

wherein ρ_{w} is the density of water at 23° C.

TABLE 5
VOC values of first coating composition

| | | | | Comparative | Comparative |
|---|---|---|---|---|---|
| | Example 1 | Example 2 | Example 3 | Example 1 | Example 2 |
| VOC | 230 | 250 | 260 | 220 | 240 |

TABLE 6
VOC values of second coating composition

| | | | | Comparative | Comparative |
|---|---|---|---|---|---|
| | Example 4 | Example 5 | Example 6 | Example 3 | Example 4 |
| VOC | 330 | 320 | 350 | 510 | 350 |

The above VOC content data show that for the first coating compositions, Examples 1-3 may maintain the same VOC level as Comparative Examples 1-2, but achieve higher wet film solid contents and get better color effects (FI value and G value). However, for the second coating compositions, Comparative Examples 3-4 cannot get good color effects regardless of high VOC content or low VOC content. However, Examples 4-5 may get satisfactory color effects while ensuring low VOC contents.

### 4—Other Properties

TABLE 7
Property tests of coating systems - other properties

| | | Testing | Examples |
|---|---|---|---|
| Test item | Test description/standard | method | 6-11 |
| Hardness | Pencil hardness ≥ H | GB/T 6739 | Pass |
| Impact | ≥20 kg · cm | GB/T 1732 | Pass |
| resistance | | | |
| strength | | | |
| Cupping | Not less than 3 mm | GB/T 9753 | Pass |
| Stone chip | Better than 5B | ASTM3170 | Pass |
| resistance | | | |
| Water | After immersion at (40 ± 2)°C for 96 h, the | GB/T 5209 | Pass |
| resistance | appearance should be free of defects such as | | |
| | foaming and wrinkling, and the adhesion | | |
| | should be in level 0-1 | | |
| Accelerated | Exposure time of 1500 h; comprehensive | GB/T 1865 | Pass |
| aging | rating of crack, foaming, wrinkling, | | |
| resistance | bronzing, etc., reaching the national standard | | |
| | level 1; adhesion in level 1, and light loss ≤20%; | | |
| | Hardness ≥ HB; impact resistance | | |
| | strength ≥20 kg · cm | | |
| Appearance | Smooth and flat, free of particles, bright as a | QC/T 484 | Pass |
| of paint film | mirror, glossness ≥90 | | |

As represented by the above performance data, Examples 6-11 may not only obtain relatively good color effects, but also meet the standard requirements for coating applications in terms of other appearance and mechanical properties.

While specific aspects of the present disclosure have been illustrated and described, it would be obvious to those skilled in the art that various other changes and modifications can be made without departing from the spirit and scope of the present disclosure. The attached claims are therefore intended to cover all such changes and modifications that fall within the scope of the present disclosure.

1. A coating system, comprising: a lower coating formed from a first coating composition, and an upper coating formed from a second coating composition comprising an effect pigment, the first coating composition and the second coating composition being cured simultaneously, wherein the upper coating has a dry film thickness of 3-20 μm, and a difference between foil solid contents of the lower coating and the upper coating is at least 20 wt %.

2. The coating system of claim 1, wherein the difference between foil solid contents of the lower coating and the upper coating is at least 30 wt %.

3. The coating system of claim 1, wherein the difference between foil solid contents of the lower coating and the upper coating is at least 40 wt %.

4. The coating system of claim 1, wherein the lower coating has a foil solid content of at least 50 wt %.

5. The coating system of claim 1 wherein the upper coating has a foil solid content of 30 wt % or less.

6. The coating system of claim 1, wherein the first coating composition has a solid content of 30-45 wt %.

7. The coating system of claim 1, wherein the second coating composition has a solid content of 8-20 wt %.

8. The coating system of claim 1, wherein the lower coating has a dry film thickness of 5-20 μm.

9. The coating system of claim 1, wherein the effect pigment comprises a silver dollar type pigment.

10. The coating system of claim 1, wherein the effect pigment has an aspect ratio of 50:1 to 200:1.

11. The coating system of claim 1, wherein the second coating composition has a pigment-binder ratio of 0.02:1 to 0.3:1.

12. The coating system of claim 1, wherein the first coating composition and/or the second coating composition is a waterborne coating composition.

13. The coating system of claim 1, wherein each of the first coating composition and the second coating composition has a VOC content of less than 420 g/L.

14. The coating system of claim 1, wherein the first coating composition comprises a polyurethane resin, an acrylic resin, and/or an acrylate grafted polyurethane resin.

15. The coating system of claim 14, wherein a weight ratio of the polyurethane resin to the acrylic resin and/or the acrylate grafted polyurethane resin is 0.1:1 to 0.9:1.

16. The coating system of claim 14, wherein the polyurethane resin has a weight-average molecular weight of 2,000-200,000, and an average particle size of 200-2,000 nm.

17. The coating system of claim 14, wherein the acrylic resin has a hydroxyl value of 50-150 mgKOH/g, an acid value of 1-50 mgKOH/g, and an average particle size of 100-1,000 nm.

18. The coating system of claim 14, wherein the acrylate grafted polyurethane resin has a hydroxyl value of 10-100 mgKOH/g, an acid value of 1-50 mgKOH/g, an average particle size of 100-2,000 nm, and a weight-average molecular weight of 2,000-200,000.

19. The coating system of claim 14, wherein the first coating composition farther comprises a pigment comprising carbon black, and optionally titanium white.

20. The coating system of claim 1, wherein the second coating composition comprises a high Tg acrylic resin and a high Tg polyurethane resin, the high Tg acrylic resin having a Tg greater than 40° C., and the high Tg polyurethane resin having a Tg greater than 30° C.

21. The coating system of claim 20, wherein a weight ratio of the high Tg acrylic resin to the high Tg polyurethane resin is 10-80:5-50.

22. The coating system of claim 20, wherein the high Tg acrylic resin has a hydroxyl value of 10-100 mgKOH/g, an acid value of 1-70 mgKOH/g, and an average particle size of 100-1,000 nm.

23. The coating system of claim 20, wherein the high Tg polyurethane resin has a weight-average molecular weight of 2,000-15,000.

24. The coating system of claim 20, wherein the second coating composition further comprises a thickener comprising a silicate thickener, an acrylic thickener, a polyurethane thickener, a polyamide wax thickener, a polyurea thickener, or combinations thereof.

25. The coating system of claim 14, wherein the first coating composition and/or the second coating composition further comprises a melamine formaldehyde resin, wherein a functional group ratio of the sum of imino groups and hydroxymethyl groups to alkoxy groups in the melamine formaldehyde resin is 5:80 to 50:50.

26. A coated substrate, comprising a substrate and the coating system of claim 1 coated on at least a portion of the substrate.

27. The coated substrate of claim 26, wherein the substrate comprises a metal.

28. (canceled)

29. (canceled)
